(19) United States
(12) Patent Application Publication
(10) Pub. No.: US 2016/0049694 A1
(43) Pub. Date: Feb. 18, 2016

(54) POSITIVE ELECTRODE ACTIVE MATERIAL FOR SODIUM MOLTEN SALT BATTERIES, POSITIVE ELECTRODE FOR SODIUM MOLTEN SALT BATTERIES, AND SODIUM MOLTEN SALT BATTERY

(71) Applicant: SUMITOMO ELECTRIC INDUSTRIES, LTD., Osaka-shi (JP)

(72) Inventors: Atsushi Fukunaga, Osaka-shi (JP); Shinji Inazawa, Osaka-shi (JP); Koji Nitta, Osaka-shi (JP); Shoichiro Sakai, Osaka-shi (JP); Eiko Imazaki, Osaka-shi (JP); Koma Numata, Osaka-shi (JP)

(21) Appl. No.: 14/773,665

(22) PCT Filed: Dec. 19, 2013
(86) PCT No.: PCT/JP2013/084043

§ 371 Date: Sep. 8, 2015

(30) Foreign Application Priority Data
Mar. 8, 2013 (JP) 2013-047169

(51) Int. Cl. H01M 10/39; H01M 4/131; H01M 4/485

(52) U.S. Cl. CPC H01M 10/399; H01M 4/485; H01M 4/131; H01M 2004/028

(57) ABSTRACT

A positive electrode active material for sodium molten salt batteries includes a sodium-containing metal oxide that can electrochemically intercalate and deintercalate sodium ions, wherein a ratio by mass of sodium carbonate is 500 ppm or less. A ratio by mass of sodium carbonate in the positive electrode active material is more preferably 100 ppm or less.

### TECHNICAL FIELD

The present invention relates to a sodium molten salt battery, which contains a molten salt having sodium-ion conductivity as an electrolyte, and particularly relates to improvement in a positive electrode active material for sodium molten salt batteries.

### BACKGROUND ART

In recent years, the technology of converting natural energy of sunlight, wind power, or the like to electric energy has attracted attention. Also, non-aqueous electrolyte secondary batteries have been increasingly demanded as batteries with high energy densities capable of storing much electric energy. Among the non-aqueous electrolyte secondary batteries, lithium ion secondary batteries are promising in view of lightness of weight and high electromotive force. However, lithium ion secondary batteries each contain an organic solvent as an electrolyte component and thus has the defect of low heat resistance. Further, with increasing market of lithium ion secondary batteries, the price of lithium resources is increasing.

Therefore, the development of molten salt batteries using a flame-retardant molten salt as an electrolyte is advanced. Molten salts have excellent thermal stability and safety that can be relatively easily secured, and are suitable for continuous use in a high-temperature region. Also, the molten salt batteries can use as an electrolyte a molten salt containing cations of an inexpensive alkali metal (particularly sodium) other than lithium, thereby decreasing the production cost.

The expression “molten salt batteries” is a generic name for batteries containing a salt in a molten state (molten salt) as an electrolyte. The molten salt is a liquid (ionic liquid) having ionic conductivity.

A sodium-containing transition metal oxide, for example, sodium chromite, is used as a positive electrode active material of a positive electrode of a molten salt battery using sodium as an ionic conduction carrier (hereinafter referred to as a “sodium molten salt battery”). Sodium chromite is produced by, for example, mixing chromium oxide and sodium carbonate and heating the resultant mixture at a predetermined temperature for a predetermined time. A positive electrode can be formed by using, for example, a mixture containing a positive electrode active material, a conductive carbon material, and a binder.

The presence of excess moisture in a sodium molten salt battery may cause side reaction not contributing to electrode reactions. Examples of the side reaction include a hydrolysis reaction of a molten salt. When a hydrolysis reaction of a molten salt occurs, gas may be produced, or a reaction product may serve as a resistance component and inhibit smooth electrode reactions. From the viewpoint of suppressing the side reaction of a molten salt, various researches are conducted for decreasing a moisture amount in a battery (refer to, for example, Patent Literature 1).

### CITATION LIST

### Patent Literature

PTL 1: Japanese Unexamined Patent Application Publication No. 2012-162416

### SUMMARY OF INVENTION

### Technical Problem

However, it is difficult to satisfactorily suppress the side reaction only by decreasing a moisture amount in a battery. According to recent investigation, it has been found that side reaction due to sodium carbonate remaining in a positive electrode active material is made apparent by decreasing the moisture amount in a battery. For example, when a positive electrode potential reaches about 3 V due to charge, carbon dioxide is produced by reaction of a conductive carbon material with sodium carbonate in a positive electrode. The reaction is represented by a reaction formula below.

2Na₂CO₃+C→4Na⁺+3CO₂

When carbon dioxide is excessively produced, the pressure in a battery is increased, leading to a decrease in reliability of the battery. Also, deterioration in battery characteristics is caused by the consumption of the conductive carbon material by side reaction with sodium carbonate. Therefore, from the viewpoint of improving battery characteristics and reliability, it is very important to decrease the amount of sodium carbonate remaining in a positive electrode active material.

### Solution to Problem

In an aspect of the present invention, the present invention relates to a positive electrode active material for sodium molten salt batteries, the positive electrode active material containing a sodium-containing metal oxide that can electrochemically intercalate and deintercalate sodium ions, wherein a ratio by mass of sodium carbonate is 500 ppm or less.

### Advantageous Effects of Invention

According to the present invention, the amount of sodium carbonate remaining in the positive electrode active material is decreased, and thus side reaction due to sodium carbonate, which does not contribute to charge-discharge reactions, can be suppressed. Therefore, it is possible to provide a sodium molten salt battery having excellent battery characteristics and reliability.

### BRIEF DESCRIPTION OF DRAWINGS

FIG. 1 is a front view of a positive electrode according to an embodiment of the present invention.

FIG. 2 is a cross-sectional view taken along line II-II in FIG. 1.

FIG. 3 is a front view of a negative electrode according to an embodiment of the present invention.

FIG. 4 is a cross-sectional view taken along line IV-IV in FIG. 3.

FIG. 5 is a partially cut-away perspective view of a battery case of a molten salt battery according to an embodiment of the present invention.

FIG. 6 is a schematic longitudinal cross-sectional view taken along line VI-VI in FIG. 5.

### DESCRIPTION OF EMBODIMENTS

### Description of Embodiments of the Invention

First, contents of embodiments of the present invention are described by listing.

In an aspect of the present invention, the present invention relates to a positive electrode active material for sodium molten salt batteries, the positive electrode active material containing a sodium-containing metal oxide that can electrochemically intercalate and deintercalate sodium ions, wherein a ratio by mass of sodium carbonate is 500 ppm or less. The positive electrode active material for sodium molten salt batteries suppresses side reaction even in an environment peculiar to the secondary batteries using a molten salt electrolyte, thereby improving battery characteristics and reliability of a sodium molten salt battery.

The sodium-containing metal oxide is preferably a compound represented by the general formula: Na₁₋ₓM¹ₓCr_{1-y}M²_{y}O₂ (0≦x≦⅔, 0≦y≦0.7, and M¹ and M² are each independently a metal element other than Cr and Na). The positive electrode active material containing the sodium-containing metal oxide is low-cost and is excellent in reversibility of structural change with charge and discharge, and thus a sodium molten salt battery having excellent cycle characteristics can be produced.

In another aspect of the present invention, the present invention relates to a positive electrode for sodium molten salt batteries, the positive electrode including a positive electrode current collector and a positive electrode active material layer adhering to the positive electrode current collector, and the positive electrode active material layer containing the positive electrode active material described above and a conductive carbon material. The positive electrode satisfactorily suppresses the side reaction of sodium carbonate with the conductive carbon material and thus a sodium molten salt battery having excellent cycle characteristics and reliability can be produced.

Also, a ratio by mass of sodium carbonate contained in the positive electrode for sodium molten salt batteries is preferably 500 ppm or less. The effect of suppressing side reaction can be easily achieved by limiting the ratio by mass of sodium carbonate contained in the positive electrode to 500 ppm or less.

In addition, a ratio by mass of moisture contained in the positive electrode is preferably 200 ppm or less. This decreases the moisture amount in the battery, and thus reaction of moisture with sodium ions serving as carriers which play a role of ion conduction in the sodium molten salt battery is suppressed. Therefore, the effect of suppressing gas generation by decreasing sodium carbonate becomes significant.

In a further aspect of the present invention, the present invention relates to a sodium molten salt battery, the battery including a positive electrode, a negative electrode, a separator interposed between the positive electrode and the negative electrode, and an electrolyte, wherein the electrolyte includes a molten salt containing at least sodium ions, and the positive electrode is the positive electrode for sodium molten salt batteries described above.

When the concentration of sodium ions contained in the electrolyte accounts for 2 mol % or more and further 5 mol % or more of cations contained in the electrolyte, carbon dioxide tends to be easily produced. Although the cause for this is not necessarily clear, this is estimated to be relevant to the relatively higher operating temperature of a battery using a molten salt as an electrolyte.

Specifically, it is estimated that when the concentration of sodium ions is increased, fine sodium dendrites (metallic sodium) are easily produced, and thus the side reaction of sodium with the conductive carbon material is accelerated. Also, it is considered that when the operating temperature of the battery becomes relatively high, the side reaction is further accelerated. Therefore, when sodium ions account for 2 mol % or more and further 5 mol % or more of cations contained in the electrolyte, it is particularly important that the ratio by mass of sodium carbonate contained in the positive electrode active material is 500 ppm or less.

According to an embodiment of the present invention, the design capacity of the sodium molten salt battery electrolyte is 10 Ah or more. Since the amount of sodium carbonate remaining in the positive electrode active material of the present invention is sufficiently decreased, excellent cycle characteristics and reliability can be achieved even by a relatively large-size sodium molten salt battery susceptible to gas generation.

### Details of Embodiments of the Invention

An aspect of the present invention includes the positive electrode active material used for sodium molten salt batteries, which uses sodium as carriers of ion conduction. However, the positive electrode active material contains a sodium-containing metal oxide that can electrochemically intercalate and deintercalate sodium ions.

The sodium-containing metal oxide can be produced by, for example, mixing sodium carbonate and metal oxide and heating the resultant mixture at a predetermined temperature for a predetermined time. In this case, a considerable amount of sodium carbonate used as a raw material generally remains in the sodium-containing metal oxide product. However, when a positive electrode potential reaches about 3 V due to charge, carbon dioxide is produced by side reaction of the sodium carbonate remaining in the positive electrode active material with the conductive carbon material contained as a conductive material in the positive electrode. In addition, the side reaction is easily made apparent in an environment of about 90° C. which is a general operating temperature of sodium molten salt batteries. A more excessive amount of sodium carbonate remaining in the positive electrode active material increases the influence of the side reaction, resulting in decreases in battery characteristics and reliability.

Therefore, in the present invention, the amount of sodium carbonate remaining in the positive electrode active material for sodium molten salt batteries is decreased to 500 ppm or less. A molten salt battery using the positive electrode active material exhibits excellent battery characteristics and reliability even in an operating environment peculiar to the sodium molten salt batteries in which the side reaction is easily made apparent. From the viewpoint of further improvements in battery characteristics and reliability, the ratio by mass of sodium carbonate in the positive electrode active material is more preferably decreased to 100 ppm or less.

The ratio by mass of sodium carbonate remaining in the positive electrode active material can be determined by, for example, an ion chromatographic method.

Specifically, sodium carbonate contained in the positive electrode active material is dissolved in ion exchange water by mixing the positive electrode active material with ion exchange water, thereby preparing a measurement sample. Then, the ratio by mass of sodium carbonate remaining in the positive electrode active material can be determined by ion chromatographic measurement of the concentration of carbonate ions (CO₃²⁻) in the measurement sample.

The sodium-containing metal oxide preferably has a layered structure having an interlayer distance which allows sodium ions to intercalate and deintercalate. For example, sodium chromite (NaCrO₂) can be used as the sodium-containing metal oxide. Also, Cr or Na of sodium chromite may be partially substituted by another element and, for example, sodium chromite is preferably a compound represented by the general formula: Na₁₋ₓM¹Cr_{1-y}M²_{y}O₂ (0≦x≦⅔, 0≦y≦0.7, and M¹ and M² are each independently a metal element other than Cr and Na). In the general formula, x more preferably satisfies 0≦x≦0.5, and M¹ and M² are each preferably, for example, at least one selected from the group consisting of Ni, Co, Mn, Fe, and Al. In addition MI is an element occupying a Na site, and M² is an element occupying a Cr site.

Also, sodium iron-manganese oxide (Na_{2/3}Fe_{1/3}Mn_{2/3}O₂ and the like) can be used as the sodium-containing metal oxide. In addition, Fe, Mn, or Na of sodium iron-manganese oxide may be partially substituted by another element. For example, preferred is a compound represented by the general formula: Na_{2/3-x}M³ₓFe_{1/3-y}Mn_{2/3-z}M⁴_{y+z}O₂ (−⅓≦x≦⅔, 0≦y≦⅓, o≦z≦⅓, and M³ and M⁴ are each independently a metal element other than Fe, Mn, and Na). In the general formula, x more preferably satisfies 0≦x≦⅓. In addition, M³ is preferably at least one selected from the group consisting of Ni, Co, Mn, Fe, and Al, and M⁴ is preferably, for example, at least one selected from the group consisting of Ni, Co, and Al. Further, M³ is an element occupying a Na site, and M⁴ is an element occupying a Fe or Mn site.

Examples which can be used as the sodium-containing metal oxide include Na₂FePO₄F, NaVPO₄F, NaCoPO₄, NaNiPO₄, NaMnPO₄, NaMn_{1.5}Ni_{0.5}O₄, NaMn_{0.5}Ni_{0.5}O₂, and the like. The sodium-containing metal oxides may be used alone or in combination of a plurality of types.

The average particle diameter (particle diameter D50 at 50% cumulative volume in a volume particle size distribution) of the positive electrode active material is preferably 2 μm or more and 20 μm or less. The positive electrode active material has raw material reactivity and the amount of sodium carbonate remaining can be further decreased. The average particle diameter D50 is a value measured by a laser diffraction scattering method using, for example, a laser diffraction-type particle size distribution measuring apparatus. This is true for description below.

An example of a method for producing the positive electrode active material for sodium molten salt batteries is described below.

Sodium carbonate is mixed with a metal compound (oxide, hydroxide, or the like) containing a required metal. From the viewpoint of sufficiently decreasing the amount of sodium carbonate remaining in the resultant positive electrode active material, the amount of the metal compound in a raw material mixture containing sodium carbonate and the metal compound is preferably 0 to 3 mol % larger than the stoichiometric amount. The positive electrode active material containing the sodium-containing metal oxide can be produced by heating the raw material mixture in an inert atmosphere such as nitrogen and argon under predetermined conditions. The pressure of the inert atmosphere is preferably 8.1×10⁴ Pa to 1.2×10⁵ Pa (0.8 atm to 1.2 atm) and more preferably 9.1×10⁴ Pa to 1.1×10⁵ Pa (0.9 atm to 1.1 atm). For example, the heating temperature is preferably 850° C. to 950° C. and more preferably 850° C. to 900° C. The heating time is preferably 3 hours to 20 hours and more preferably 5 hours to 10 hours.

The average particle diameter D50 of the metal compound is preferably 0.05 μm or more and 5 μm or less and more preferably 0.1 μm or more and 3 μm or less. The metal compound has high reactivity, and thus a more amount of sodium carbonate is consumed by the reaction to produce the positive electrode active material.

Therefore, the amount of sodium carbonate remaining in the positive electrode active material is more easily decreased.

The average particle diameter D50 of sodium carbonate is preferably 0.05 μm or more and 5 μm or less and more preferably 0.1 μm or more and 3 μm or less. The sodium carbonate has high reactivity, and thus much of sodium carbonate is consumed by the reaction to produce the positive electrode active material. Therefore, the amount of sodium carbonate remaining in the positive electrode active material is more easily decreased.

Next, a method for producing the positive electrode active material containing sodium chromite which is a sodium-containing metal oxide is described in further detail as an example.

The positive electrode active material containing sodium chromite (NaCrO₂) can be produced by heating, under predetermined conditions, a raw material mixture containing chromium oxide in an excess of 0 to 3 mol % and preferably 0.5 to 1 mol % over the amount of sodium carbonate on a stoichiometric basis. The excess chromium oxide remains unreacted in the positive electrode active material but has substantially no influence on battery characteristics.

That is, the raw material mixture preferably contains 1 mole to 1.03 moles and more preferably 1.005 moles to 1.01 moles of chromium per mole of sodium. The positive electrode active material containing sodium carbonate at a ratio by mass of 500 ppm or less can be produced by heating the raw material mixture under conditions such as the temperature and time controlled according the amount of chromium in the raw material mixture.

Next, each of the components of the sodium molten salt battery and the positive electrode for sodium molten salt batteries is specifically described.

### [Positive Electrode]

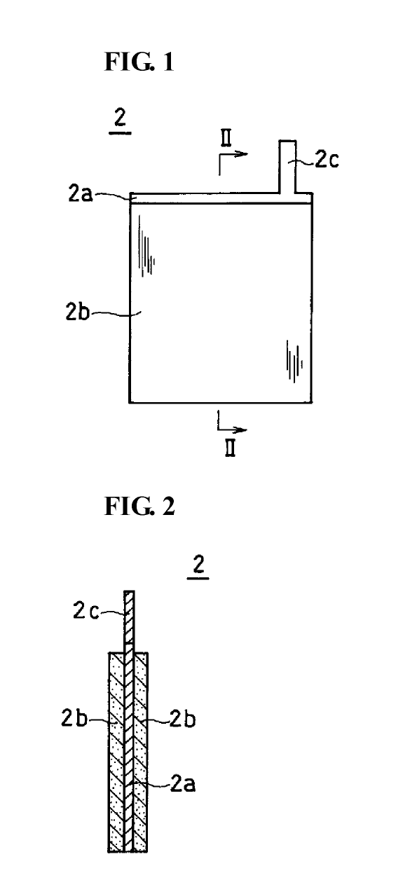

FIG. 1 is a front view of a positive electrode according to an embodiment of the present invention, and FIG. 2 is a cross-sectional view taken along line II-II in FIG. 1.

A positive electrode 2 for sodium molten salt batteries includes a positive electrode current collector 2a and a positive electrode active material layer 2b adhering to the positive electrode current collector 2a. The positive electrode active material layer 2b contains a positive electrode active material as an essential component and may further contain a conductive carbon material, a binder, and the like as optional components.

The ratio by mass of moisture contained in the positive electrode is preferably 200 ppm or less. The ratio by mass of moisture in the positive electrode can be decreased to 200 ppm or less by, for example, drying the positive electrode under reduced pressure at a temperature of 90° C. to 200° C. for 2 hours to 24 hours. The pressure of a drying atmosphere is, for example, 10 Pa or less and preferably controlled to 1 Pa or less.

This method is advantageous in that it is simple and does not increase the production. The moisture can be more effectively removed from the positive electrode by previously replacing the air in a treatment atmosphere with inert gas (for example, nitrogen, helium, or argon) or dry air having a dew point temperature of −50° C. or less before establishing a reduced-pressure atmosphere as the treatment atmosphere.

The ratio by mass of moisture contained in the positive electrode is a moisture amount measured by the Karl Fischer method. The moisture amount in the positive electrode is a total moisture amount in the positive electrode current collector and the positive electrode active material layer.

Specifically, the positive electrode as a sample is placed together with a catholyte in a cell of a moisture content measuring apparatus, and moisture is measured. The catholyte contains alcohol, a base, sulfur dioxide, iodide ions, and the like. The Karl Fischer method is classified into a capacity titration method and a coulometric titration method, but the coulometric titration method with high analytical precision is used. In addition, a commercial Karl Fischer moisture titrator (for example, “MKC-610” manufactured by Kyoto Electronics Manufacturing Co., Ltd.) can be used as the moisture content measuring apparatus.

The ratio by mass of moisture contained in the positive electrode is measured by placing a sample in a cell of a moisture content measuring apparatus filled with a fresh catholyte in a nitrogen atmosphere. The weight of the sample may be, for example, within a range of 0.05 g to 5 g.

Examples of the conductive carbon material contained in the positive electrode include graphite, carbon black, carbon fibers, and the like. The conductive carbon material easily secures a good conductive path but causes a side reaction with sodium carbonate remaining in the positive electrode active material. However, in the present invention, the amount of sodium carbonate remaining is significantly decreased, and thus a good conductive path can be secured while the side reaction is satisfactorily suppressed. Among the conductive carbon materials, carbon black is particularly preferred because a satisfactory conductive path can be easily formed by using a small amount. Examples of the carbon black include acethylene black, ketjen black, thermal black, and the like. The amount of the conductive carbon material is preferably 2 parts by mass to 15 parts by mass and more preferably 3 parts by mass to 8 parts by mass based on 100 parts by mass of the positive electrode active material.

The binder plays the function of bonding the positive electrode active material and fixing the positive electrode active material to the positive electrode current collector. Examples of the binder which can be used include fluorocarbon resins, polyamide, polyimide, polyamide-imide, and the like. Examples of the fluorocarbon resins which can be used include polyvinylidene fluoride (PVDF), polytetrafluoroethylene (PTFE), tetrafluoroethylene-hexafluoropropylene copolymers, vinylidene fluoride-hexafluoropropylene copolymers, and the like. The amount of the binder is preferably 1 part by mass to 10 parts by mass and more preferably 3 parts by mass to 5 parts by mass based on 100 parts by mass of the positive electrode active material.

The ratio by mass of sodium carbonate contained in the entire positive electrode is generally limited to 500 ppm by limiting the ratio by mass of sodium carbonate contained in the positive electrode active material to 500 ppm or less. However, when the conductive carbon material or the binder contains a small amount of sodium carbonate, the amount of sodium carbonate contained in the entire positive electrode is increased by that amount. Even in this case, from the viewpoint of effectively suppressing the side reaction, the ratio by mass of sodium carbonate contained in the positive electrode is preferably limited to 500 ppm or less.

A metal foil, a nonwoven fabric made of metal fibers, a metal porous sheet, or the like can be used as the positive electrode current collector 2a. A metal constituting the positive electrode current collector is preferably aluminum or an aluminum alloy because of its stability at a positive electrode potential but is not particularly limited. When an aluminum alloy is used, the amount of metal components (for example, Fe, Si, Ni, Mn, and the like) other than aluminum is preferably 0.5% by mass or less. The thickness of the metal foil serving as the positive electrode current collector is, for example, 10 μm to 50 μm, and the thickness of the metal fiber nonwoven fabric or metal porous sheet is, for example, 100 μm to 600 μm. In addition, a lead piece 2c for current collection may be formed on the positive electrode current collector 2a. The lead piece 2c may be formed integrally with the positive electrode current collector as shown in FIG. 1 or the lead piece separately formed may be connected to the positive electrode current collector by welding or the like.

### [Negative Electrode]

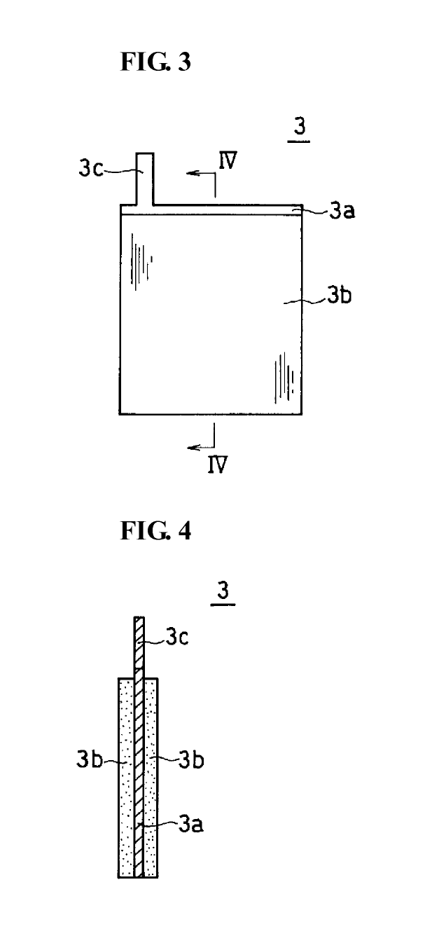

FIG. 3 is a front view of a negative electrode according to an embodiment of the present invention, and FIG. 4 is a cross-sectional view taken along line IV-IV in FIG. 3.

A negative electrode 3 includes a negative electrode current collector 3a and a negative electrode active material layer 3b adhering to the negative electrode current collector 3a.

For example, sodium, a sodium alloy, or a metal which can be alloyed with sodium can be used for the negative electrode active material layer 3b. The negative electrode includes the negative electrode current collector composed of a first metal and a second metal which covers at least a portion of the surface of the negative electrode current collector. In this case, the first metal is a metal which is not alloyed with sodium, and the second metal is a metal which is alloyed with sodium.

The ratio by mass of moisture contained in the negative electrode is preferably 300 ppm or less. The ratio by mass of moisture in the negative electrode can be decreased to 300 ppm or less by, for example, drying the negative electrode under reduced pressure at a temperature of 90° C. to 200° C. for 2 hours to 24 hours. The pressure of a drying atmosphere is, for example, 10 Pa or less and preferably controlled to 1 Pa or less. Like in the positive electrode, the moisture can be more effectively removed by previously replacing the air in a treatment atmosphere with inert gas or dry air having a dew point temperature of −50° C. or less.

The ratio by mass of moisture contained in the negative electrode may be measured by the Karl Fischer method in the same way as for the positive electrode except that the negative electrode is used as a sample.

A metal foil, a nonwoven fabric made of glass fibers, a metal porous sheet, or the like can be used as the negative electrode current collector composed of the first metal. The first metal is preferably aluminum, an aluminum alloy, copper, a copper alloy, nickel, a nickel alloy, or the like because such a metal is not alloyed with sodium and is stable at a negative electrode potential. Among these, aluminum and an aluminum alloy are preferred in view of excellent lightness of weight. For example, the same aluminum alloy as the example described for the positive electrode current collector may be used as an aluminum alloy. The thickness of the metal foil serving as the negative electrode current collector is, for example, 10 μm to 50 μm, and the thickness of the metal fiber nonwoven fabric or metal porous sheet is, for example, 100 μm to 600 μm. In addition, a lead piece 3c for current collection may be formed on the negative electrode current collector 3a. The lead piece 3c may be formed integrally with the negative electrode current collector as shown in FIG. 3 or the lead piece separately formed may be connected to the negative electrode current collector by welding or the like.

Examples of the second metal include zinc, a zinc alloy, tin, a tin alloy, silicon, a silicon alloy, and the like. Among these, zinc and a zinc alloy are preferred in view of good wettability with the molten salt. The thickness of the negative electrode active material layer composed of the second metal is preferably, for example, 0.05 μm to 1 μm. In addition, the amount of metal components (for example, Fe, Ni, Si, Mn, and the like) other than zinc or tin in a zinc alloy or tin alloy is preferably 0.5% by mass or less.

An example of a preferred form of the negative electrode includes a negative electrode current collector composed of aluminum or an aluminum alloy (the first metal) and zinc, a zinc alloy, tin, or a tin alloy (the second metal) which covers at least a portion of the surface of the negative electrode current collector. This negative electrode has a high capacity and little deteriorates over a long period of time.

The negative electrode active material layer composed of the second metal can be produced by, for example, attaching or pressure-bonding a sheet of the second metal to the negative electrode current collector. Also, the second metal may be gasified and adhered to the negative electrode current collector by a vapor phase method such as a vacuum deposition method and a sputtering method, or fine particles of the second metal may be adhered by an electrochemical method such as a plating method. The thin and uniform negative electrode active material layer can be formed by the vapor phase method or the plating method.

The negative electrode active material layer 3b may be a mixture layer containing a negative electrode active material as an essential component and further containing a binder, a conductive agent, and the like as optional components. The same examples of materials as described for the constituent components of the positive electrode can be used for the binder and the conductive agent used in the negative electrode. The amount of the binder is preferably 1 part by mass to 10 parts by mass and more preferably 3 parts by mass to 5 parts by mass based on 100 parts by mass of the negative electrode active material. The amount of the conductive agent is preferably 5 parts by mass to 15 parts by mass and more preferably 5 parts by mass to 10 parts by mass based on 100 parts by mass of the negative electrode active material.

From the viewpoint of thermal stability and electrochemical stability, a sodium-containing titanium compound, non-graphitizable carbon (hard carbon), or the like is preferably used as the negative electrode active material constituting the negative electrode mixture layer. The sodium-containing titanium compound is preferably sodium titanate and, more specifically, at least one selected from the group consisting of Na₂Ti₃O₇ and Na4Ti₅O₁₂ is preferably used. Also, Ti or Na of sodium titanate may be partially substituted by another element. Examples of the compound which can be used include Na₂₋ₓM⁵ₓTi_{3-y}M⁶_{y}O₇ (0≦x≦ 3/2, 0≦y≦ 8/3, and M⁵ and M⁶ are each independently a metal element other than Ti and Na, for example, at least one selected from the group consisting of Ni, Co, Mn, Fe, Al, and Cr), Na₄₋ₓM⁷ₓTi_{5-y}M⁸_{y}O₁₂ (0≦x≦ 11/3, 0≦y≦ 14/3, and M⁷ and M⁸ are each independently a metal element other than Ti and Na, for example, at least one selected from the group consisting of Ni, Co, Mn, Fe, Al, Cr and the like). The sodium-containing titanium compound may be used singly or a combination of a plurality of types may be used. The sodium-containing titanium compound may be combined with non-graphitizable carbon. In addition, M⁵ and M⁷ are each an element occupying a Na site, and M⁶ and M⁸ are each an element occupying a Ti site.

The non-graphitizable carbon is a carbon material which does not develop a graphite structure even by heating in an inert atmosphere and represents a material containing fine graphite crystals arranged in random directions and having nano-order voids between crystal layers. Since the diameter of sodium ions which is a typical alkali metal is 0.95 angstroms, the size of the voids is preferably sufficiently larger than this diameter. The average particle diameter of the non-graphitizable carbon (particle diameter D50 at 50% cumulative volume in a volume particle size distribution) may be, for example, 3 μm to 20 μm, and is preferably 5 μm to 15 μm from the viewpoint of enhancing the filling property of the negative electrode active material in the negative electrode and suppressing side reaction with the electrolyte (molten salt). The specific surface area of the non-graphitizable carbon may be, for example, 1 m²/g to 10 m²/g and is preferably 3 m²/g to 8 m²/g from the viewpoint of securing sodium ion acceptability and suppressing side reaction with the electrolyte. The non-graphitizable carbon may be used singly or a combination of a plurality of types may be used.

### [Electrolyte (Molten Salt)]

A salt which becomes an ionic liquid within an operating temperature region of batteries (preferably 90° C. or less and more preferably 70° C. or less) is used as the electrolyte (molten salt). The molten salt contains at least, as cations, sodium ions which serve as charge carriers in the molten salt battery.

The concentration of sodium ions contained in the electrolyte preferably accounts for 2 mol % or more and further 5 mol % or more of cations contained in the electrolyte. Such an electrolyte has excellent sodium ion conductivity and can easily achieve a high capacity even in the case of charge/discharge with a high current.

Examples of the molten salt which can be used include compounds represented by N(SO₂X¹)(SO₂X²)—M (wherein X¹ and X² are each independently a fluorine atom or a fluoroalkyl group having 1 to 8 carbon atoms, and M is an alkali metal or an organic cation having a nitrogen-containing hetero-ring). The N(SO₂X¹)(SO₂X²)—M includes at least N(SO₂X¹)(SO₂X²)—Na.

The separator is interposed between the positive electrode and the negative electrode in the sodium molten salt battery, and the molten salt is impregnated into the voids of the separator. Before the battery is formed, the amount of moisture contained in the molten salt is preferably, for example, 100 ppm or less, more preferably 50 ppm or less, and particularly preferably 10 ppm or less in terms of mass ratio. By using the molten salt and the positive electrode, the negative electrode, and the separator each having a sufficiently decreased moisture amount, the amount of moisture contained in the sodium molten salt battery (including the moisture coming from the positive electrode, the negative electrode, and the separator) can be satisfactorily decreased.

A fluoroalkyl group represented by X¹ and X² may be an alkyl group in which some of the hydrogen atoms are substituted by fluorine atoms or may be a perfluoroalkyl group in which all of the hydrogen atoms are substituted by fluorine atoms. From the viewpoint of decreasing the viscosity of an ionic liquid, at least one of X¹ and X² is preferably a perfluoroalkyl group, and both of X¹ and X² are more preferably perfluoroalkyl groups. Having 1 to 8 carbon atoms can suppress an increase in the melting point of the electrolyte and is thus advantageous for forming a low-viscosity ionic liquid. In particular, from the viewpoint of producing a low-viscosity ionic liquid, the perfluoroalkyl group preferably has 1 to 3 carbon atoms and more preferably 1 or 2 carbon atoms. Specifically, X¹ and X² may be each independently a trifluoromethyl group, a pentafluoroethyl group, a heptafluoropropyl group, or the like.

Specific examples of bissulfonylamide anion represented by N(SO₂X¹)(SO₂X²) include bis(fluorosulfonyl)amide anion (FSA⁻), bis(trifluoromethylsulfonyl)amide anion (TFSA⁻), bis(pentafluoroethylsulfonyl)amide anion, fluorosulfonyl trifluoromethylsulfonylamide anion (N(FSO₂)(CF₃SO₂)), and the like.

Examples of an alkali metal other than sodium represented by M include potassium, lithium, rubidium, and cesium. Among these, potassium is preferred.

A cation having a pyrrolidinium skeleton, an imidazolium skeleton, a pyridinium skeleton, a piperidinium skeleton, or the like can be used as an organic cation having a nitrogen-containing hetero-ring represented by M. In particular, a cation having a pyrrolidinium skeleton is preferred in view of the point that it can form a molten salt having a low melting point and is also stable at a high temperature.

The organic cation having a pyrrolidinium skeleton is represented by, for example, a general formula (1):

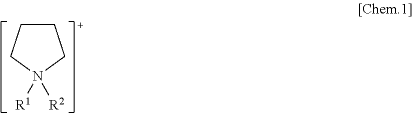

wherein R¹ and R² are each independently an alkyl group having 1 to 8 carbon atoms. Having 1 to 8 carbon atoms can suppress an increase in the melting point of the electrolyte and is thus advantageous for forming a low-viscosity ionic liquid. In particular, from the viewpoint of producing a low-viscosity ionic liquid, the alkyl group preferably has 1 to 3 carbon atoms and more preferably 1 or 2 carbon atoms. Specifically, R¹ and R² may be each independently a methyl group, an ethyl group, a propyl group, an isopropyl group, or the like.

Specific examples of the organic cation having a pyrrolidinium skeleton include methylpropylpyrrolidinium cation, ethylpropylpyrrolidinium cation, methylethylpyrrolidinium cation, dimethylpyrrolidinium cation, diethylpyrrolidinium cation, and the like. These may be used alone or in combination of plural types. Among these, methylpropylpyrrolidinium cation (Py13⁺) is particularly preferred in view of high thermal stability and electrochemical stability.

Specific examples of the molten salt include a salt of sodium ion and FSA⁻ (NaFSA), a salt of sodium ion and TFSA⁻ (NaTFSA), a salt of Py13⁺ and FSA⁻ (Py13FSA), a salt of Py13⁺ and TFSA⁻ (Py13TFSA), and the like.

The molten salt preferably has as a low melting temperature as possible. From the viewpoint of decreasing the melting point of the molten salt, a mixture of two or more salts is preferably used. For example, when a first salt of sodium with bissulfonylamide anion is used, a second salt of cation other than sodium with bissulfonylamide anion is preferably used in combination with the first salt. The bissulfonylamide anions forming the first salt and the second salt may be the same or different.

When NaFSA, NaTFSA, or the like is used as the first salt, a salt of potassium ion with FSA⁻ (KFSA), a salt of potassium with TFSA⁻ (KTFSA), or the like is preferably used as the second salt. More specifically, a mixture of NaFSA and KFSA or a mixture of NaTFSA and KTFSA is preferably used. In this case, the molar ratio (first salt/second salt) of the first salt to the second salt is, for example, 40/60 to 70/30, preferably 45/55 to 65/35, and more preferably 50/50 to 60/40 in view of the melting point of the electrolyte and balance between viscosity and ionic conductivity.

When a salt of Py13 is used as the first salt, the salt has a low melting point and has low viscosity even at room temperature. However, by using a sodium salt, a potassium salt, or the like as the second salt in combination with the first salt, the melting point is further decreased. When Py13FSA, Py13TFSA, or the like is used as the first salt, NaFSA, NaTFSA, or the like is preferably used as the second salt. More specifically, a mixture of Py13FSA and NaFSA or a mixture of Py13TFSA and NaTFSA is preferably used. In this case, the molar ratio (first salt/second salt) of the first salt to the second salt is, for example, 98/2 to 80/20 and preferably 95/5 to 85/15 in view of the melting point of the electrolyte and balance between viscosity and ionic conductivity.

Besides the salts described above, the electrolyte can contain various additives. However, from the viewpoint of securing ionic conductivity and thermal stability, the molten salt preferably occupies the electrolyte at a ratio of 90% by mass to 100% by mass and more preferably 95% by mass to 100% by mass of the electrolyte filled in the battery.

### [Separator]

The material of the separator may be selected in view of the operating temperature of the battery, but glass fibers, a silica-containing polyolefin, a fluorocarbon resin, alumina, polyphenylene sulfite (PPS), or the like is preferably used from the viewpoint of suppressing side reaction with the electrolyte. In particular, a glass fiber nonwoven fabric is preferred in view of its inexpensiveness and high heat resistance. Also, a silica-containing polyolefin and alumina are preferred in view of excellent heat resistance. Further, a fluorocarbon resin and PPS are preferred in view of heat resistance and corrosion resistance. In particular, PPS is excellent in resistance to fluorine contained in the molten salt.

The amount of moisture in the separator is preferably, for example, 10 ppm to 200 ppm in terms of mass ratio. The separator having such a moisture amount can be produced by, for example, drying at a drying temperature of 90° C. or more (more preferably 90° C. to 300° C.) under a reduced-pressure environment of 10 Pa or less, preferably 1 Pa or less, and more preferably 0.4 Pa or less. Like in the positive electrode and the negative electrode, the moisture can be more effectively removed by previously replacing the air in a treatment atmosphere with inert gas or dry air having a dew point temperature of −50° C. or less. The ratio by mass of moisture contained in the separator may be measured by the Karl Fischer method in the same way as for the positive electrode and the negative electrode except that the separator is used as a sample.

The thickness of the separator is 10 μm to 500 μm and more preferably 20 μm to 50 μm. This is because with the thickness within this range, internal short-circuiting can be effectively prevented, and the volume fraction of the separator occupying the electrode group can be suppressed, and thus a high capacity density can be obtained.

### [Electrode Group]

The molten salt battery is used in a state where the electrode group including the positive electrode and the negative electrode and the electrolyte are housed in a battery case. The electrode group is formed by stacking or winding the positive electrode and the negative electrode with the separator interposed therebetween. In this case, a metal-made battery case is used, and one of the positive electrode and the negative electrode is conducted to the battery case, so that a portion of the battery case can be used as a first external terminal. On the other hand, the other of the positive electrode and the negative electrode is connected to a second external terminal by using a lead piece or the like, the second external terminal being led out from the battery case in a state of being insulated from the battery case.

Next, the structure of a sodium molten salt battery according to an embodiment of the present invention is described. The sodium molten salt battery includes a positive electrode, a negative electrode, a separator interposed between the positive electrode and the negative electrode, and an electrolyte. The electrolyte includes a molten salt containing at least sodium ions. In particular, a relatively large-size sodium molten salt battery which has a design capacity of 10 Ah or more is susceptible to gas generation, it is very effective to suppress the side reaction by using the positive electrode active material according to the present invention. The positive electrode active material according to the present invention is particularly effective in use for a relatively large-capacity sodium molten salt battery electrolyte which has a design capacity of, for example, 33 Ah or less, particularly 15 Ah to 30 Ah.

A sodium molten salt battery according to an embodiment is described with reference to the figures. However, the structure of the sodium molten salt battery according to the present invention is not limited to the structure described below.

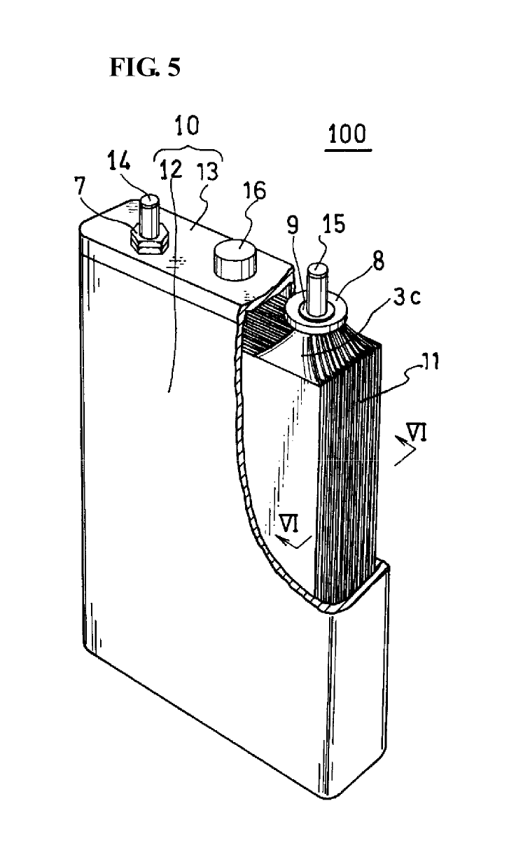

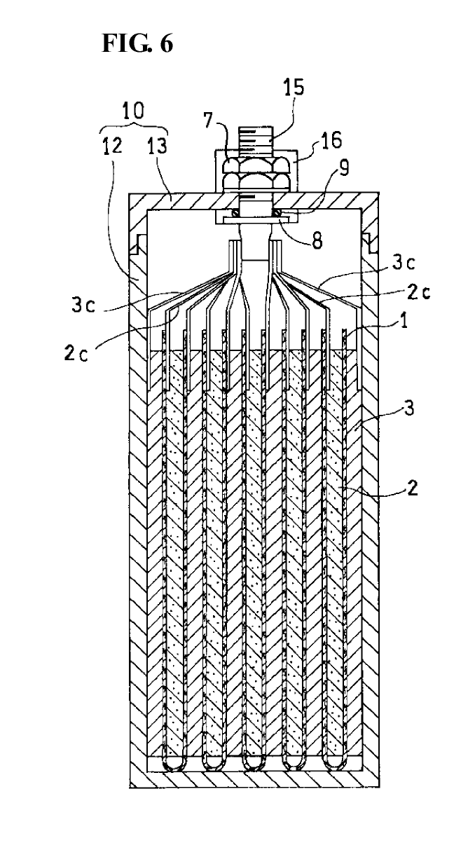

FIG. 5 is a perspective view of a molten salt battery in which a battery case is partially cut away, and FIG. 6 is a schematic longitudinal cross-sectional view taken along line VI-VI in FIG. 5.

A molten salt battery 100 is provided with a stacked-type electrode group 11, an electrolyte (not shown), and a square aluminum-made battery case 10 which houses these components. The battery case 10 includes a bottomed container body 12 having an open upper portion and a cover portion 13 which closes the open upper portion. In assembling the molten salt battery 100, first the electrode group 11 is formed and inserted in the container body 12 of the battery case 10. Then, there is performed the step of injecting the electrolyte in a molten state into the container body 12 and impregnating the electrolyte into voids of the separator 1, the positive electrode 2, and the negative electrode 3 which constitute the electrode group 11. Alternatively, the electrode group may be impregnated with the heated electrolyte in a molten state (ionic liquid), and then the electrode group containing the electrolyte may be housed in the container body 12.

An external positive electrode terminal 14 is provided near one of the sides of the cover portion 13 so as to pass through the cover portion 13 in a conductive state with the battery case 10, and an external negative electrode terminal 15 is provided near the other side of the cover portion 13 so as to pass through the cover portion 13 in an insulating state from the battery case 10. In addition, a safety valve 16 is provided at a center of the cover portion 13 in order to release the gas generated in the battery case 10 when the internal pressure is increased.

The stacked-type electrode group 11 includes a plurality of the positive electrodes 2, a plurality of the negative electrodes 3, and a plurality of the separators 1 each interposed between the positive electrode 2 and the negative electrode 3, any one of which has a rectangular sheet shape. In FIG. 6, the separator 1 is formed in a bag-like shape so as to surround the positive electrode 2, but the shape of the separator 1 is not particularly limited. A plurality of the positive electrodes 2 and a plurality of the negative electrodes 3 are alternately arranged in a stacking direction in the electrode group 11.

Further, a positive electrode lead piece 2c may be formed at one of the ends of each of the positive electrodes 2. The positive electrode lead pieces 2c of the plurality of the positive electrodes 2 are bundled and connected to the external positive electrode terminal 14 provided on the cover portion 13 of the battery case 10, and consequently the plurality of the positive electrodes 2 are connected in parallel. Similarly, a negative electrode lead piece 3c may be formed at one of the ends of each of the negative electrodes 3. The negative electrode lead pieces 3c of the plurality of the negative electrodes 3 are bundled and connected to the external negative electrode terminal 15 provided on the cover portion 13 of the battery case 10, and consequently the plurality of the negative electrodes 3 are connected in parallel. The bundle of the positive electrode lead pieces 2c and the bundle of the negative electrode lead pieces 3c are preferably disposed with a space therebetween on the right and the left of an end surface of the electrode group 11 so as to avoid contact therebetween.

Each of the external positive electrode terminal 14 and the external negative electrode terminal 15 has a columnar shape and has a screw groove provided in at least a portion exposed to the outside. A nut 7 is engaged with the screw groove of each of the terminals and the nut 7 is fixed to the cover portion 13 by rotating the nut 7. Further, a flange portion 8 is provided on each of the terminals in a portion housed in the battery case so that the flange portion 8 is fixed to the inner surface of the cover portion 13 through a washer 9 by rotating the nut 7.

Next, the present invention is more specifically described on the basis of examples. However, the present invention is not limited to the examples below.

### EXAMPLES

### Example 1

### (Preparation of Positive Electrode Active Material)

Sodium carbonate (Na₂CO₃) having an average particle diameter D50 of 2.0 μm and chromium oxide (Cr₂O₃) having an average particle diameter D50 of 1.5 μm were mixed in such amounts that a molar ratio of sodium to chromium was 1:1.01. The resultant mixture was heated in a nitrogen atmosphere at 900° C. for 8 hours to prepare a positive electrode active material containing sodium chromite (NaCrO₂).

### (Measurement of Amount of Sodium Carbonate)

Next, the ratio by mass of sodium carbonate contained in the positive electrode active material was determined by the following method.

The resultant positive electrode active material was mixed with a predetermined amount of ion exchange water to prepare a measurement sample. The concentration of carbonate ion (CO₃²⁻) in the measurement sample was measured by ion chromatography (ion chromatographic analyzer ICS-3000 manufactured by Japan Dionex Co., Ltd.), but the concentration could not be measured. Therefore, it was found that the ratio by mass of sodium carbonate contained in the positive electrode active material is less than the measurement limit of 1 ppm.

### (Formation of Positive Electrode)

The resultant positive electrode active material was ground and classified to an average particle diameter of 10 μm. A positive electrode paste was prepared by dispersing 85 parts by mass of the positive electrode active material having an average particle diameter of 10 μm, 10 parts by mass of acethylene black (conductive carbon material), and 5 parts by mass of polyvinylidene fluoride (binder) in N-methyl-2-pyrrolidone (NMP) used as a dispersion medium. The resultant positive electrode paste was applied to both surfaces of an aluminum foil having a thickness of 20 μm, dried, rolled, and then cut into predetermined dimensions to form a positive electrode having a positive electrode active material layer having a thickness of 80 μm and formed on each of both surfaces thereof. The dimensions of the positive electrode were a width of 46 mm, a length of 46 mm, and a total thickness of 180 μm.

### (Formation of Negative Electrode)

A sodium metal having a thickness of 100 μm was applied each of both surfaces of an aluminum foil having a thickness of 20 μm. In addition, a negative electrode lead made of aluminum was welded to the aluminum foil.

### (Separator)

A separator having a thickness of 50 μm and made of a polyolefin with a porosity of 90% was prepared. The separator was cut into dimensions of 50 mm×50 mm.

### (Electrolyte)

An electrolyte including a mixture of sodium bis(fluorosulfonyl)amide (NaFSA) and potassium bis(fluorosulfonyl)amide (KFSA) at a molar ratio of 56:44 was prepared. The electrolyte (molten salt) had a melting point of 61° C.

### (Formation of Sodium Molten Salt Battery)

First, the positive electrode, the negative electrode, and the separator were dried by heating at 90° C. or more under a reduced pressure of 0.3 Pa. Drying was performed until the moisture amounts in the positive electrode and the negative electrode were 50 ppm and 30 ppm, respectively, and the moisture amount in the separator was 100 ppm.

The moisture amount in each of the positive electrode, the negative electrode, and the separator was measured by the Karl Fischer method (coulometric titration method) using a moisture amount measuring apparatus (MKC-610 manufactured by Kyoto Electronics Manufacturing Co., Ltd.) and 5 g of a measurement sample.

On the other hand, 10 parts by mass of solid sodium relative to 100 parts by mass of the molten salt was immersed in the molten salt in an atmosphere with a dew point temperature of −50° C. or less, followed by stirring at 90° C. As a result, the moisture amount in the molten salt was decreased to less than 1 ppm.

Then, the positives electrodes and the negative electrodes were stacked with the separator interposed between each positive electrode and negative electrode, thereby forming an electrode group. Then, the resultant electrode group was housed in a battery case made of aluminum, and the electrolyte was injected into the battery case to form a sodium molten salt battery with a design capacity of 500 mAh.

### [Evaluation]

### (i) Cycle Characteristics

The resultant sodium molten salt battery was heated to 90° C. in a constant-temperature chamber, and at a stabilized temperature, 1000 cycles of charge and discharge were performed under conditions (1) to (3) in one cycle described below to determine a charge capacity (capacity retention rate) at the 1000th cycle relative to a discharge capacity at the first cycle. The results are shown in Table 1.

(1) Charge to a charge termination voltage of 3.5 V at a charge current of 0.2 C

(2) Charge to a termination current of 0.01 C at a constant voltage of 3.5 V

(3) Discharge to a discharge termination voltage of 2.5 V at a discharge current of 0.2 C

### (ii) Evaluation of Presence of Gas Generation

The thickness of the battery after the evaluation (i) of cycle characteristics was measured by using a dial gauge. The presence of swelling of the battery was confirmed by comparing the thickness after the evaluation of cycle characteristics with the thickness of the battery before the evaluation of cycle characteristics. When swelling of the battery was less than 3% of the initial thickness, swelling of the battery was determined as “No”, while when swelling of the battery was 3% or more of the initial thickness, swelling of the battery was determined as “Yes”.

### Example 2

A positive electrode active material was prepared by the same method as in Example 1 except that in preparing the positive electrode active material, sodium carbonate and chromium oxide were mixed in such amounts that a molar ratio of sodium to chromium was 1:1. The ratio by mass of sodium carbonate contained in the resultant positive electrode active material was 100 ppm.

### Example 3

A positive electrode active material was prepared by the same method as in Example 2 except that in preparing the positive electrode active material, a heating time was 5 hours. The ratio by mass of sodium carbonate contained in the resultant positive electrode active material was 400 ppm.

### Example 4

A positive electrode active material was prepared by the same method as in Example 1 except that in preparing the positive electrode active material, a heating time was 5 hours. The ratio by mass of sodium carbonate contained in the resultant positive electrode active material was 200 ppm.

### Example 5

A positive electrode active material was prepared by the same method as in Example 1 except that in preparing the positive electrode active material, a heating temperature was 850° C. The ratio by mass of sodium carbonate contained in the resultant positive electrode active material was 500 ppm.

### Comparative Example 1

A positive electrode active material was prepared by the same method as in Example 2 except that in preparing the positive electrode active material, a heating temperature was 850° C. and a heating time was 5 hours. The ratio by mass of sodium carbonate contained in the resultant positive electrode active material was 0.1% (1000 ppm).

### Comparative Example 2

A positive electrode active material was prepared by the same method as in Example 1 except that in preparing the positive electrode active material, sodium carbonate and chromium oxide were mixed in such amounts that a molar ratio of sodium to chromium was 1:0.99. The ratio by mass of sodium carbonate contained in the resultant positive electrode active material was 900 ppm.

### Comparative Example 3

A positive electrode active material was prepared by the same methods as in Example 2 except that in preparing the positive electrode active material, a heating temperature was 850° C. The ratio by mass of sodium carbonate contained in the resultant positive electrode active material was 600 ppm.

A sodium molten salt battery was formed and evaluated by the same methods as in Example 1 except that each of the positive electrode active materials described above was used. The results are shown in Table 1.

TABLE 1

| | | | Heating | | Ration by mass | | Cycle character- |
|---|---|---|---|---|---|---|---|
| | Mixing ratio | | condition | | of Na₂CO₃ in | Swelling | istic Capacity |
| | (molar ratio) | | Temper- | | positive electrode | of battery | retention rate |
| | Na₂CO₃ | Cr₂O₃ | ature | Time | active material | due to gas | after 10000 cycles |
| Example 1 | 1.00 | 1.01 | 900° C. | 8 h | N.D. | No | 90% |
| Example 2 | 1.00 | 1.00 | 900° C. | 8 h | 100 ppm | No | 89% |
| Example 3 | 1.00 | 1.00 | 900° C. | 5 h | 400 ppm | No | 86% |
| Example 4 | 1.00 | 1.01 | 900° C. | 5 h | 200 ppm | No | 88% |
| Example 5 | 1.00 | 1.01 | 850° C. | 8 h | 500 ppm | No | 84% |
| Comparative | 1.00 | 1.00 | 850° C. | 5 h | 0.1% | Yes | 60% |
| Example 1 | | | | | | | |
| Comparative | 1.00 | 0.99 | 900° C. | 8 h | 900 ppm | Yes | 68% |
| Example 2 | | | | | | | |
| Comparative | 1.00 | 1.00 | 850° C. | 8 h | 600 ppm | Yes | 75% |
| Example 3 | | | | | | | |

According to Table 1, swelling of the battery was not observed in any one of the sodium molten salt batteries of Examples 1 to 5 in which the ratio by mass of sodium carbonate contained in the resultant positive electrode active material was 500 ppm. Also, any one of the batteries of Examples 1 to 5 showed excellent cycle characteristics. This is considered to be due to the satisfactory suppression of side reaction due to sodium carbonate because of a decrease in ratio by mass of sodium carbonate.

On the other hand, swelling of the battery considered to be due to the generation of a large amount of carbon dioxide was observed in any one of the sodium molten salt batteries of Comparative Examples 1 to 3 in which the ratio by mass of sodium carbonate contained in the resultant positive electrode active material exceeded 500 ppm or less. Also, any one of the batteries of Comparative Examples 1 to 3 showed a large decrease in capacity retention rate as compared with the batteries of Examples 1 to 5. This is considered to be due to the fact that the conductive carbon material contained in the positive electrode is lost by reaction with sodium carbonated remaining in the positive electrode active material, thereby failing to secure a satisfactory conductive path.

### INDUSTRIAL APPLICABILITY

A positive electrode active material for sodium molten salt batteries according to the present invention suppresses carbon dioxide generated due to side reaction of sodium carbonate with a conductive carbon material, and thus can provide a sodium molten salt battery having excellent cycle characteristics and reliability. The sodium molten salt battery according to the present invention is useful for, for example, a domestic or industrial large-size power storage apparatus, a power source of an electric car or a hybrid car, and the like.

### REFERENCE SIGNS LIST

1: separator

2: positive electrode

2a: positive electrode current collector

2b: positive electrode active material layer

2c: positive electrode lead piece

3: negative electrode

3a: negative electrode current collector

3b: negative electrode active material layer

3c: negative electrode lead piece

7: nut

8: flange portion

9: washer

10: battery case

11: electrode group

12: container body

13: cover portion

14: external positive electrode terminal

15: external negative electrode terminal

16: safety valve

100: molten salt battery

1. A positive electrode active material for sodium molten salt batteries, the positive electrode active material comprising a sodium-containing metal oxide that can electrochemically intercalate and deintercalate sodium ions, wherein a ratio by mass of sodium carbonate is 500 ppm or less.

2. The positive electrode active material for sodium molten salt batteries according to claim 1, wherein the sodium-containing metal compound is a compound represented by the general formula: Na₁₋ₓM¹ₓCr_{1-y}M²_{y}O₂ (0≦x≦⅔, 0≦y≦0.7, and M¹ and M² are each independently a metal element other than Cr and Na).

3. A positive electrode for sodium molten salt batteries, the positive electrode comprising a positive electrode current collector and a positive electrode active material layer adhering to the positive electrode current collector, wherein the positive electrode active material layer contains the positive electrode active material according to claim 1 and a conductive carbon material.

4. The positive electrode for sodium molten salt batteries according to claim 3, wherein a ratio by mass of sodium carbonate contained in the positive electrode is 500 ppm or less.

5. The positive electrode for sodium molten salt batteries according to claim 3, wherein a ratio by mass of moisture contained in the positive electrode is 200 ppm or less.

6. A sodium molten salt battery, the battery comprising a positive electrode, a negative electrode, a separator interposed between the positive electrode and the negative electrode, and an electrolyte,
wherein the electrolyte includes a molten salt containing at least sodium ions; and
the positive electrode is the positive electrode for sodium molten salt batteries according to any one of claims 3.

7. The sodium molten salt battery according to claim 6, wherein a concentration of the sodium ions contained in the electrolyte accounts for 2 mol % or more of cations contained in the electrolyte.

8. The sodium molten salt battery according to claim 6, wherein a design capacity is 10 Ah or more.

9. The positive extrode active material for sodium molten salt batteries according to claim 1, wherein a ration by mass of sodium carbonate in the positive electrode active material is 100 ppm or less.
